(19) United States
(12) Patent Application Publication
(10) Pub. No.: US 2018/0085932 A1
(43) Pub. Date: Mar. 29, 2018

(54) CUTTER

(71) Applicant: Hsiu-Man Yu Chen, Taichung (TW)

(72) Inventor: Hsiu-Man Yu Chen, Taichung (TW)

(21) Appl. No.: 15/276,749

(22) Filed: Sep. 26, 2016

(51) Int. Cl. B26B 3/08; B26B 11/00

(52) U.S. Cl. CPC B26B 3/08; B26B 11/006

(57) ABSTRACT

A cutter includes a main body and a cutting unit. One end of the main body has a cutting head. A top edge of the cutting head is provided with a protection rib extending in the direction of a short axis of the main body. Two ends of the protection rib are provided with two protection pieces disposed apart from the main body. The cutting head, the protection rib and the protection pieces cover the cutting unit. The cutting unit has pointed end portions protruding out of two sides of a top surface of the protection rib and a cutting-edge portion protruding out of a bottom surface of the protection rib. The pointed end portions and the cutting-edge portion can be used to remove various packing members. The protection pieces are disposed apart from the main body. The present invention can enhance the work efficiency to remove packing members.

### BACKGROUND OF THE INVENTION

### 1. Field of the Invention

The present invention relates to a cutter, and more particularly to a cutter able to cut and remove various kinds of packaging members.

### 2. Description of the Prior Art

As shown in FIG. 1, a conventional cutter comprises a handle portion 1 and a head portion 2. The head portion 2 has two passages 4 symmetrical to a long axis 3 of the handle portion 1. The head portion 2 is provided with a blade 5. Two opposing sides of the blade 5 are a scraping portion 6 and a cutting portion 7. The scraping portion 6 extends out of the head portion 2. The cutting portion 7 extends out of the passages 4. When the user wants to remove a packing member, such as an adhesive tape, from a packing box or a packing bag, he/she just holds the handle portion 1, with the scraping portion 6 to scrape the adhesive tape back and forth. The cutting portion 7 can be used to cut the adhesive tape. The cutter is applied to cut and remove various packing members. However, although the aforesaid cutter can be used to cut and remove various packing members, it still has some drawbacks. Through the scraping portion 6 of the cutter to scrape the adhesive tape back and forth for the cutter to pierce the adhesive tape and then through the cutting portion 7 to unseal the adhesive tape, the operation is strenuous and time-consuming. The cutter cannot be operated smoothly. Besides, the scraping portion 6 is exposed out of the head portion 2, which may hurt the user when the cutter is in use or not in use. The conventional cutter is not convenient and safe for use. Accordingly, the inventor of the present invention has devoted himself based on his many years of practical experiences to solve these problems.

### SUMMARY OF THE INVENTION

The primary object of the present invention is to provide a cutter which is able to cut and remove various packaging members. The cutter can be operated smoothly and conveniently and is easy for use.

In order to achieve the aforesaid object, the cutter of the present invention comprises a main body and a cutting unit. The main body is a plate body. The main body has a long axis and a short axis. One end of the long axis of the main body is provided with a cutting head. The cutting head substantially has a trapezoid shape. The cutting head is formed with a top edge and two first flat surfaces. The top edge is provided with a protection rib extending in the direction of the short axis. Two ends of a bottom surface of the protection rib are provided with two protection pieces. Each protection piece is disposed apart from the main body. One side of each protection piece, facing a corresponding one of the first flat surfaces, has a second flat surface. The cutting head has an accommodation space therein. The main body is formed with a first opening at each of the first flat surfaces. The first opening extends to the protection rib and the second flat surface. One side of a top surface of the protection rib is formed with a second opening. The first opening and the second opening are in communication with the accommodation space. The cutting unit has a platy shape. The cutting unit is disposed in the accommodation space of the cutting head. The cutting unit has a first side and an opposing second side. The first side has a cutting-edge portion. The cutting-edge portion extends out of the first openings of the two first flat surfaces of the main body. One end of the second side is formed with a pointed end portion corresponding to the second opening. The pointed end portion protrudes out of the second opening.

When the user wants to remove a packaging member, such as an adhesive tape or a staple, the pointed end portion of the cutting unit is used to pierce the adhesive tape directly. Afterward the cutting-edge portion of the cutting unit is used to cut the adhesive tape. The pointed end portion can be used to pull up and remove the staple. Thus, the cutter of the present invention can cut and remove various packaging members. Through the cutting unit protruding out of the first openings and the protection pieces disposed apart from the main body, the cutter can be operated smoothly during cutting to enhance the work efficiency to remove packing members. The present invention is convenient for operation and easy for use.

### BRIEF DESCRIPTION OF THE DRAWINGS

FIG. 1 is a perspective view of a conventional cutter;

FIG. 2 is a perspective view of the present invention;

FIG. 3 is a front view of the present invention;

FIG. 4 is a partial sectional view of the present invention;

FIG. 5 is a sectional view taken along line 5-5 of FIG. 3;

FIG. 6 is a first schematic view of the present invention when in use, illustrating that the cutter is used to unseal a packing box;

FIG. 7 is a second schematic view of the present invention when in use, illustrating that the cutter is used to unseal a packing box; and

FIG. 8 is a schematic view of the present invention, illustrating that the cutter is used to pull out staples.

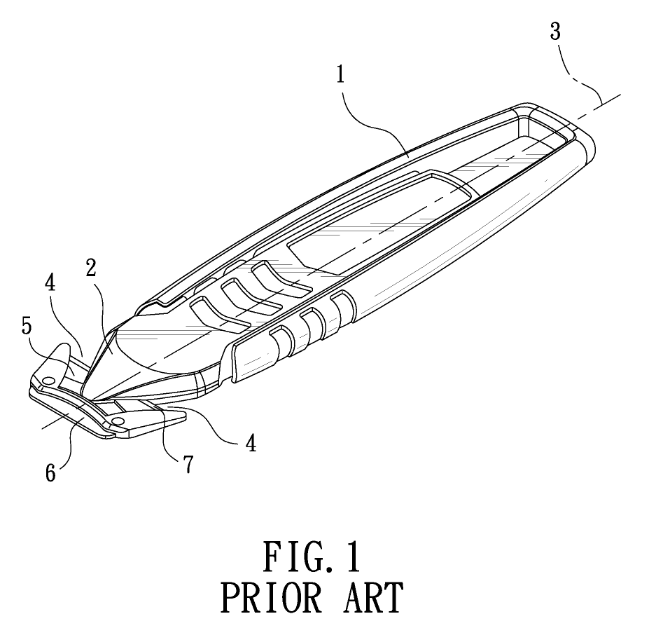

### DETAILED DESCRIPTION OF THE PREFERRED EMBODIMENTS

Embodiments of the present invention will now be described, by way of example only, with reference to the accompanying drawings.

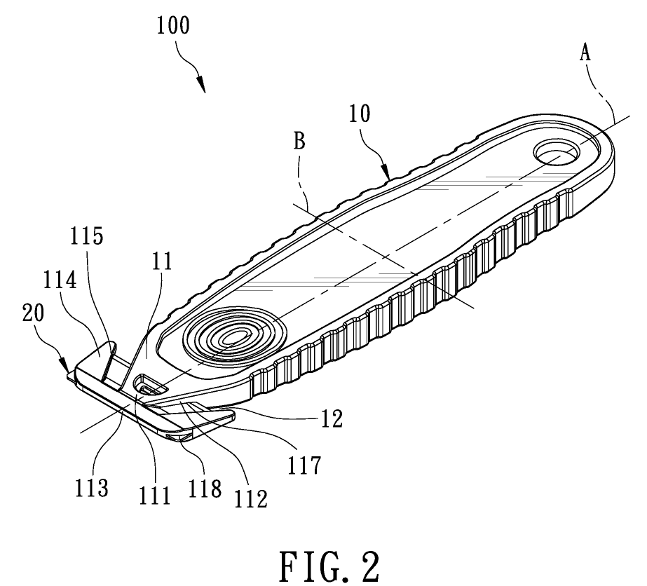

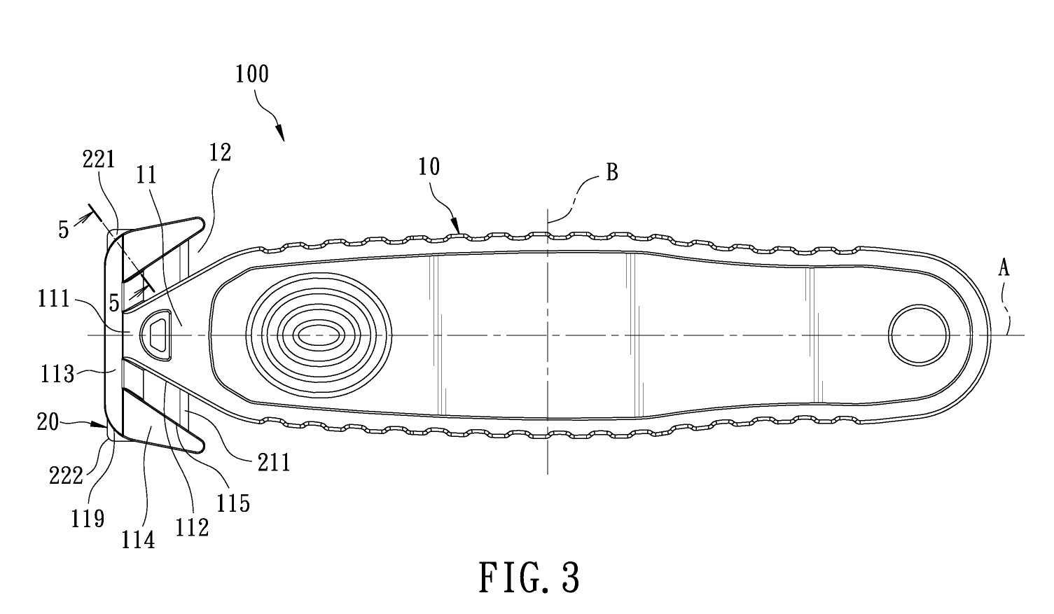

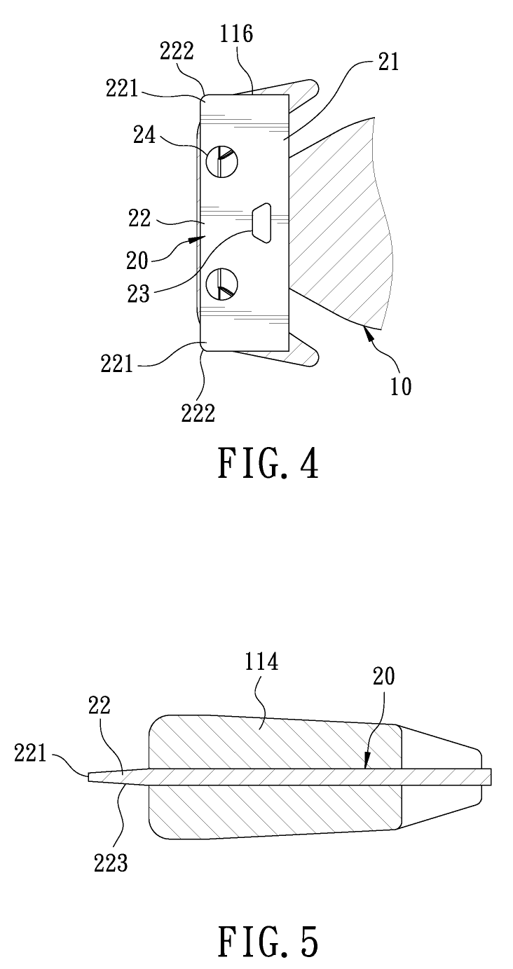

FIG. 2 is a perspective view of the present invention. FIG. 3 is a front view of the present invention. FIG. 4 is a partial sectional view of the present invention. The present invention discloses a cutter 100. The cutter 100 comprises a main body 10 and a cutting unit 20.

The main body 10 is a plate body. The main body 10 has a long axis A and a short axis B. One end 11 of the long axis A of the main body 10 is provided with a cutting head 11. The cutting head 11 substantially has a trapezoid shape. The cutting head 11 is formed with a top edge 111 and two first flat surfaces 112. The top edge 111 is provided with a transverse protection rib 113 extending in the direction of the short axis B. A top surface of the protection rib 113 is parallel to the short axis B. Two ends of a bottom surface of the protection rib 113 are provided with two protection pieces 114. Each protection piece 114 is disposed apart from the main body 10 to form a passage 12. One side of each protection piece 114, facing the corresponding first flat surface 112, has a second flat surface 115. The cutting head 11 has an accommodation space 116 therein. The main body 10 is formed with a first opening 117 at each first flat surface 112. The first opening 117 extends to the protection rib 113 and the second flat surface 115. Two sides of the top surface of the protection rib 113 are formed with a second opening 118, respectively. The first opening 117 and the second opening 118 are in communication with the accommodation space 116. In this invention, the junction of the top surface of the protection rib 113 and an outer side of each protection piece 114 has a first rounded corner 119. The second opening 118 is disposed at the first rounded corner 119.

The cutting unit 20 substantially has a rectangular platy shape. The cutting unit 20 is integrally formed in the accommodation space 116 of the cutting head 11. The cutting unit 20 has a first side 21 and an opposing second side 22. The first side 21 has a cutting-edge portion 211. The cutting-edge portion 211 extends out of the first openings 117 of the two first flat surfaces 112 of the main body 10. The second side 22 is parallel to the short axis B. Two ends of the second side 22 are respectively formed with a pointed end portion 221 corresponding to the second opening 118. The pointed end portion 221 protrudes out of the second opening 118. The pointed end portion 221 has a second rounded corner 222. The second rounded corner 222 has a radius less than that of the first rounded corner 119. Referring to FIG. 5, the pointed end portion 221 has two oblique surfaces 223 disposed opposite. The two oblique surfaces 223 are located at the relative position of the second opening 118 and gradually reduced toward a top edge of the pointed end portion 221. In addition, the cutting unit 20 has a trapezoid hole 23 close to a central portion of the first side 21 and two circular holes 24 close the second side 22.

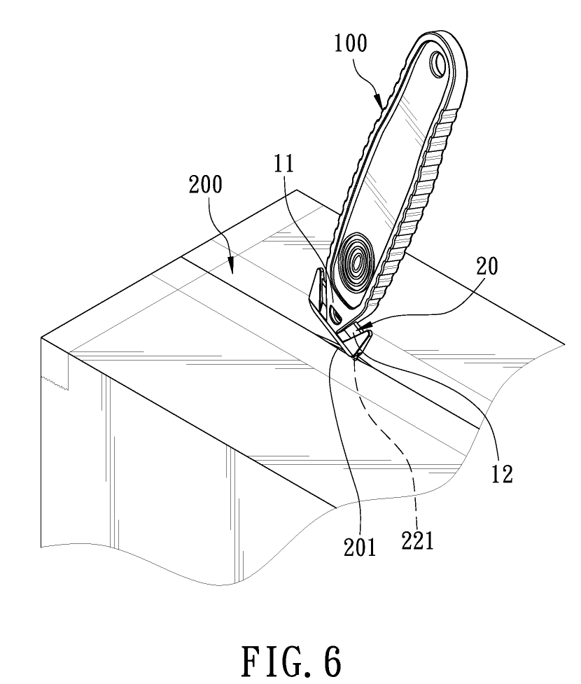

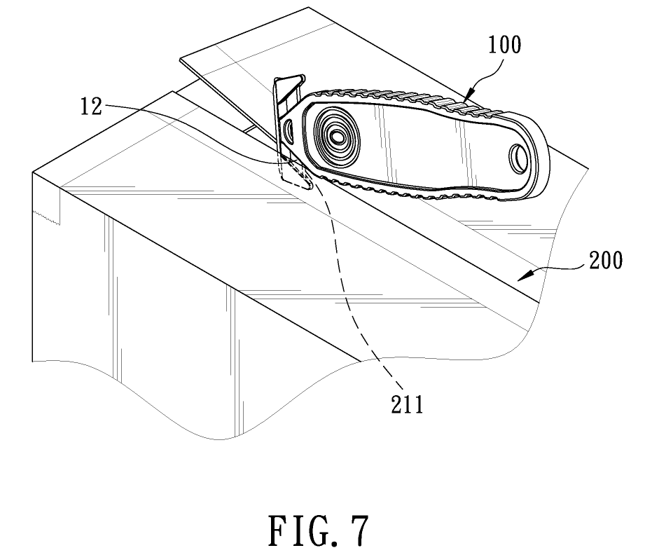

FIG. 6 is a first schematic view of the present invention when in use, illustrating that the cutter is used to unseal a packing box. FIG. 7 is a second schematic view of the present invention when in use, illustrating that the cutter is used to unseal a packing box. Please also refer to FIG. 2 to FIG. 5. In the schematic views, the packaging member is an adhesive tape 200 as an example. When the user wants to cut the adhesive tape 200 which is seamless and has its edges closely attached to a packing box, the pointed end portion 221 of the cutting unit 20 is to pierce the adhesive tape 200 to form a crack 201. Afterward the cutting head 11 in inserted into the crack 201 and the position of the cutting head 11 is adjusted for the cutting-edge portion 211 to aim at the adhesive tape 200, enabling one of the passages 12 to be located in the crack of the adhesive tape. The adhesive tape 200 is cut by the cutting-edge portion 211. Thus, the cutter 100 of the present invention can cut and remove the packaging member easily.

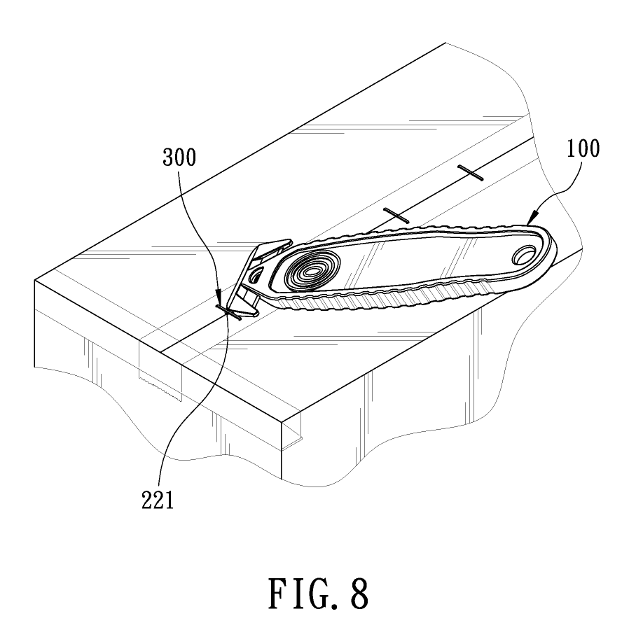

FIG. 8 is a schematic view of the present invention, illustrating that the cutter is used to pull out staples. In the schematic view, the packaging members are staples 300 as an example. When the user wants to remove the staples 300, the pointed end portion 221 of the cutter 100 can be used to pull up and remove the staples 300 from the packing box. Thereby, the cutter 100 can remove the staples totally to enhance the work efficiency to remove the packaging members from the packing box.

It is noted that the cutting-edge portion 211 and the pointed end portions 221 protrude out of the two ends of the main body 10, respectively, so the user doesn't have to change the way to hold the cutter. That is to say, both the cutting-edge portion 211 and the pointed end portions 221 can be used. As shown in FIG. 5, the pointed end portion 221 has the two oblique surfaces 223 disposed opposite. The two oblique surfaces 223 are located at the relative position of the second opening 118 and gradually reduced toward the top edge of the pointed end portion 221. Through the taper design of the pointed end portion 221, it is beneficial for the pointed end portion 221 to pierce the adhesive tape 200 or to remove the staple 300 conveniently. The work efficiency to remove the packaging members can be enhanced.

It is noted that the cutting unit 20 is positioned on a mold through the trapezoid hole 23. Through the circular holes 24, the main body 10 is integrated with the cutting hole 20 by injection molding.

It is noted that top surface of the protection rib 113 is parallel to the short axis B and the cutting unit 20 is substantially in a rectangular platy shape to prevent the cutter 100 from cutting the user when in use or not in use so as to enhance the safety of the cutter 100.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A cutter, comprising:
a main body being a plate body, the main body having a long axis and a short axis, one end of the long axis of the main body being provided with a cutting head, the cutting head substantially having a trapezoid shape, the cutting head being formed with a top edge and two first flat surfaces, the top edge being provided with a protection rib extending in the direction of the short axis, two ends of a bottom surface of the protection rib being provided with two protection pieces, each protection piece being disposed apart from the main body, one side of each protection piece, facing a corresponding one of the first flat surfaces, having a second flat surface, the cutting head having an accommodation space therein, the main body being formed with a first opening at each of the first flat surfaces, the first opening extending to the protection rib and the second flat surface, one side of a top surface of the protection rib being formed with a second opening, the first opening and the second opening being in communication with the accommodation space;
a cutting unit being disposed in the accommodation space of the cutting head, the cutting unit having a first side and an opposing second side, the first side having a cutting-edge portion, the cutting-edge portion extending out of the first openings of the two first flat surfaces of the main body, one end of the second side being formed with a pointed end portion corresponding to the second opening, the pointed end portion protruding out of the second opening;
thereby, the cutting unit being used to pierce and cut a packing member, the cutting unit protruding out of the first openings and the protection pieces to wrap the two sides of the cutting unit being disposed apart from the main body to provide a smooth operation during cutting.

2. The cutter as claimed in claim 1, wherein the cutting unit substantially has a rectangular shape, two sides of the top surface of the protection rib are provided with the second opening respectively, two ends of the second side of the cutting unit are formed with the pointed end portion respectively, and the pointed end portions of the two ends of the second side of the cutting unit protrude out of the second openings of the two sides of the top surface of the protection rib respectively.

3. The cutter as claimed in claim 2, wherein each pointed end portion has two oblique surfaces disposed opposite, and the two oblique surfaces are located at a relative position of the second opening and gradually reduced toward a top edge of the pointed end portion.

4. The cutter as claimed in claim 1, wherein the cutting unit has a trapezoid hole close to a central portion of the first side and two circular holes close the second side, wherein the trapezoid hole and the two circular holes are adapted for injection molding of the main body, enabling the main body to be integrated with the cutting unit.

5. The cutter as claimed in claim 1, wherein a junction of the top surface of the protection rib and an outer side of each protection piece has a first rounded corner, the second opening is disposed at the first rounded corner, the pointed end portion has a second rounded corner, and the second rounded corner has a radius less than that of the first rounded corner.

6. The cutter as claimed in claim 1, wherein the top surface of the protection rib is parallel to the short axis, and the second side of the cutting unit is parallel to the short axis.
